(19) United States
(12) Patent Application Publication
(10) Pub. No.: US 2026/0197746 A1
(43) Pub. Date: Jul. 9, 2026

(54) METHOD AND APPARATUS FOR MONITORING SYSTEM INFORMATION IN A WIRELESS COMMUNICATION SYSTEM

(71) Applicant: ASUS Technology Licensing Inc., Taipei City (TW)

(72) Inventor: Ko-Chiang Lin, Taipei City (TW)

(21) Appl. No.: 19/437,871

(22) Filed: Dec. 31, 2025

Related U.S. Application Data
(60) Provisional application No. 63/741,654, filed on Jan. 3, 2025.

(51) Int. Cl. H04W 48/14; H04W 74/0833

(52) U.S. Cl. CPC H04W 48/14; H04W 74/0833

(57) ABSTRACT

A method and device for a User Equipment (UE) are disclosed. In one embodiment, the UE receives a configuration of On-Demand System Information Block 1 (OD-SIB1) for a cell. Furthermore, the UE starts monitoring Physical Downlink Control Channel (PDCCH) for OD-SIB1 for the cell based on a timing that an indication is received if the UE receives the indication indicating system information status change of the cell and the UE acquires OD-SIB1 in response to reception of the indication. In addition, the UE starts monitoring PDCCH for OD-SIB1 for the cell based on a time window for monitoring a Random Access Response (RAR) if the UE acquires OD-SIB1 not in response to reception of the indication.

### CROSS-REFERENCE TO RELATED APPLICATIONS

The present Application claims the benefit of U.S. Provisional Patent Application Ser. No. 63/741,654 filed on Jan. 3, 2025, the entire disclosure of which is incorporated herein in its entirety by reference.

### FIELD

This disclosure generally relates to wireless communication networks, and more particularly, to a method and apparatus for monitoring system information in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a User Equipment (UE) are disclosed. In one embodiment, the UE receives a configuration of On-Demand System Information Block 1 (OD-SIB1) for a cell. Furthermore, the UE starts monitoring Physical Downlink Control Channel (PDCCH) for OD-SIB1 for the cell based on a timing that an indication is received if the UE receives the indication indicating system information status change of the cell and the UE acquires OD-SIB1 in response to reception of the indication. In addition, the UE starts monitoring PDCCH for OD-SIB1 for the cell based on a time window for monitoring a Random Access Response (RAR) if the UE acquires OD-SIB1 not in response to reception of the indication.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.3.1-1 of 3GPP TS 38.211 V15.7.0.

FIG. 6 is a flow chart according to one exemplary embodiment.

FIG. 7 is a flow chart according to one exemplary embodiment.

FIG. 8 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: 3GPP TS 38.211 V15.7.0, “NR; Physical channels and modulation (Release 15)”; 3GPP TS 38.213 V18.0.0, “NR; Physical layer procedures for control (Release 18)”; 3GPP TS 38.331 V17.6.0, “NR; Radio Resource Control (RRC) protocol specification (Release 17)”; RP-234065, “New WID: Enhancements of network energy savings for NR”, Ericsson; RAN1 #116bis Chairman's note; RAN1 #117 Chairman's note; RAN1 #118 Chairman's note; RAN1 #118bis Chairman's note; and RAN1 #119 Chairman's note. The standards and documents listed above are hereby expressly incorporated by reference in their entirety.

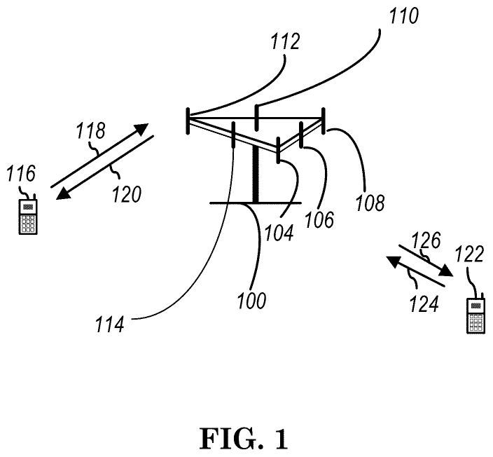

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

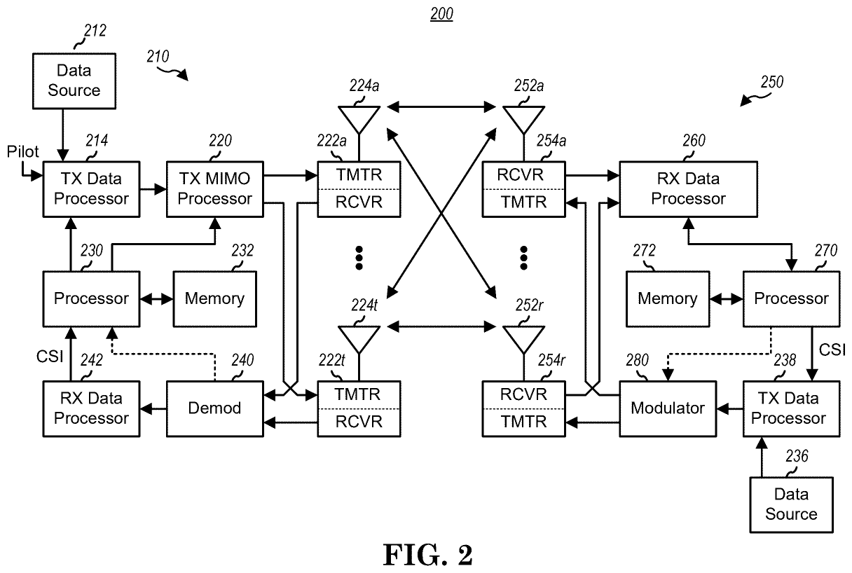

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

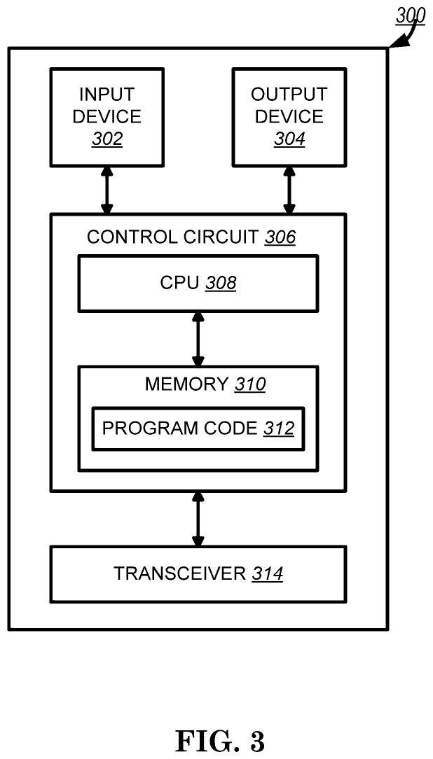

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

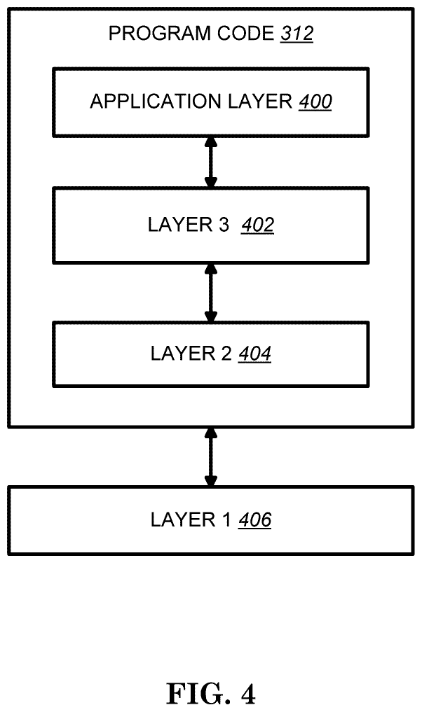

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Frame structure used in New RAT (NR) for 5G, to accommodate various types of requirement (as discussed in 3GPP TS 38.211 V15.7.0) for time and frequency resource, e.g. from ultra-low latency (~0.5 ms) to delay-tolerant traffic for Machine Type Communication (MTC), from high peak rate for Enhanced Mobile Broadband (eMBB) to very low data rate for MTC. An important focus of this study is low latency aspect, e.g. short Transmission Time Interval (TTI), while other aspect of mixing/adapting different TTIs can also be considered in the study. In addition to diverse services and requirements, forward compatibility is an important consideration in initial NR frame structure design as not all features of NR would be included in the beginning phase/release. More details of NR frame structure, channel and numerology design are provided below (as discussed in 3GPP TS 38.211 V15.7.0):

### 4.3 Frame Structure

### 4.3.1 Frames and Subframes

Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=lns duration. The number of consecutive OFDM symbols per subframe is

$${N}_{symb}^{subframe , μ} = {N}_{symb}^{slot} {N}_{slot}^{subframe , μ} .$$

Each frame is divided into two equally-sized half-frames of five subframes each with half-frame 0 consisting of subframes 0-4 and half-frame 1 consisting of subframes 5-9.

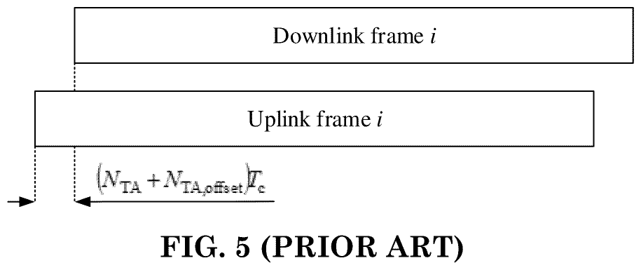

There is one set of frames in the uplink and one set of frames in the downlink on a carrier. Uplink frame number i for transmission from the UE shall start T_{TA}=(N_{TA}+N_{TA,offset})T_{c} before the start of the corresponding downlink frame at the UE where N_{TA,offset} is given by [5, TS 38.213].

[FIG. 4.3.1-1 of 3GPP TS 38.211 V15.7.0, entitled “Uplink-downlink timing relation”, is reproduced as FIG. 5]

### 4.3.2 Slots

For subcarrier spacing configuration μ, slots are numbered

$${n}_{s}^{μ} ∈ \{ 0 , ... , {N}_{slot}^{subframe , μ} - 1 \}$$

in increasing order within a subframe and

$${n}_{s , f}^{μ} ∈ \{ 0 , ... , {N}_{slot}^{frame , μ} - 1 \}$$

in increasing order within a frame. There are

$${N}_{symb}^{slot}$$

consecutive OFDM symbols in a slot where

$${N}_{symb}^{slot}$$

depends on the cyclic prefix as given by Tables 4.3.2-1 and 4.3.2-2. The start of slot nₛ^{μ} in a subframe is aligned in time with the start of OFDM symbol

$${n}_{s}^{μ} {N}_{symb}^{slot}$$

in the same subframe.

OFDM symbols in a slot can be classified as ‘downlink’, ‘flexible’, or ‘uplink’. Signaling of slot formats is described in subclause 11.1 of [5, TS 38.213].

In a slot in a downlink frame, the UE shall assume that downlink transmissions only occur in ‘downlink’ or ‘flexible’ symbols.

### 4.4.5 Bandwidth Part

A bandwidth part is a subset of contiguous common resource blocks defined in subclause 4.4.4.3 for a given numerology μᵢ in bandwidth part a on a given carrier. The starting position

$${N}_{BWP , i}^{start , μ}$$

and the number of resource blocks

$${N}_{BWP , i}^{size , μ}$$

in a bandwidth part shall fulfil

$${N}_{grid , x}^{start , μ} \leq {N}_{BWP , i}^{start , μ} < {N}_{grid , x}^{start , μ} + {N}_{grid , x}^{size , μ} and {N}_{grid , x}^{start , μ} < {N}_{BWP , i}^{start , μ} + {N}_{BWP , i}^{size , μ} \leq {N}_{grid , x}^{start , μ} + {N}_{grid , x}^{size , μ} ,$$

respectively. Configuration of a bandwidth part is described in clause 12 of [5, TS 38.213].

### 4.5 Carrier Aggregation

Transmissions in multiple cells can be aggregated. Unless otherwise noted, the description in this specification applies to each of the serving cells.

Random access procedure is introduced for several purposes, e.g. to acquire Uplink (UL) synchronization (e.g. UL Timing Advance (TA)), to ask for UL grants resource(s), to recover form beam failure and so on. Random access procedure could be categorized into contention based random access procedure and non-contention based random access procedure. For non-contention based random access procedure, a dedicated preamble (as well as dedicated Physical Random Access Channel (PRACH) resource) is assigned to the UE so that gNB could identify the UE transmitting the preamble via preamble detection/reception. For requesting system information, a dedicated preamble could be allocated for requesting a (specific) SI/SIB(s) (e.g. SIB2).

The dedicated preamble could be utilized by all UEs requesting the SI/SIB(s). (e.g. for requesting system information, identifying the UE is not necessary). The UE would then monitor random access response from the base station. The non-contention based random access random access procedure would be considered as complete successfully when/if the random access response to the transmitted preamble is received. On the other hand, for contention-based random access procedure, a preamble is randomly selected from a set of available preambles (e.g. which may depends on a purpose or situation or UE which initiates the random access procedure). After transmitting the random access preamble, the UE could monitor the corresponding random access response. After successfully receiving the random access response, the UE would transmit a Msg 3 (which could be used to identified the UE). After transmitting Msg3, the UE would monitor a contention resolution (e.g. Msg 4). If contention resolution for the UE is successfully received, the UE would consider the random access procedure is successfully finished.

More details related to random access procedure are provided in 3GPP TS 38.213 and 3GPP TS 38.331 as shown below. 3GPP TS 38.213 states:

### 8.1 Random Access Preamble

Physical random access procedure for a UE is triggered upon request of a PRACH transmission by higher layers or by a PDCCH order for a cell. A configuration by higher layers for a PRACH transmission includes the following:
A configuration for PRACH transmission on the cell [4, TS 38.211].
A preamble index, a preamble SCS, P_{PRACH,target}, a corresponding RA-RNTI when applicable [11, TS 38.321], and a PRACH resource for the cell.
A number of

$${N}_{preamble}^{rep} > 1$$

preamble repetitions for the PRACH transmission if the UE would transmit the PRACH with repetitions.

SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

An association period, starting from frame 0, for mapping SS/PBCH block indexes to PRACH occasions is the smallest integer number in the set determined by the PRACH configuration period according Table 8.1-1 such that

$${N}_{Tx}^{SSB} SS / PBCH$$

block indexes are mapped at least once to the PRACH occasions within the association period, where a UE obtains

$${N}_{Tx}^{SSB}$$

from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to

$${N}_{Tx}^{SSB} SS / PBCH$$

block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

### 8.2 Random Access Response—Type-1 Random Access Procedure

In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the last PRACH occasion corresponding to the PRACH transmission, where the symbol duration corresponds to the SCS for Type1-PDCCH CSS set as defined in clause 10.1. If

$${N}_{TA , adj}^{UE} or {N}_{TA , adj}^{common} ,$$

as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by ra-ResponseWindow.

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer. If the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH. If requested by higher layers, the UE shall be ready to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,0}=14 [6, TS 38.214]. For a PRACH transmission using 1.25 kHz or 5 kHz SCS, the UE determines N₁ assuming SCS configuration μ=0.

### 13 UE Procedure for Monitoring Type0-PDCCH CSS Sets

If during cell search a UE determines from MIB that a CORESET for Type0-PDCCH CSS set is present, as described in clause 4.1, the UE determines a number of consecutive resource blocks and a number of consecutive symbols for the CORESET of the Type0-PDCCH CSS set from controlResourceSetZero in pdcch-ConfigSIB1, as described in Tables 13-0 through 13-10, for operation without shared spectrum channel access in FR1 and FR2-1, or as described in Tables 13-1A and 13-4A for operation with shared spectrum channel access in FR1, or as described in Table 13-10A for FR2-2, and determines PDCCH monitoring occasions from searchSpaceZero in pdcch-ConfigSIB1, included in MIB, as described in Tables 13-11 through 13-15A. SFN_{c} and n_{c} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot n_{SSB,i}. The symbols of the CORESET associated with pdcch-ConfigSIB1 in MIB or with searchSpaceSIB1 in PDCCH-ConfigCommon have normal cyclic prefix. In Table 13-0, configurations with index 0 to 9 are applicable when an associated SS/PBCH block is located according to Table 5.4.3.3-2 in [8-1, TS 38.101-1], configurations with index 10 to 11 are applicable when an associated SS/PBCH block is located according to NOTE 12 of Table 5.4.3.3-1 in [8-1, TS 38.101-1], and non-interleaved CCE-to-REG mapping applies for configurations with index 6 to 9. In Table 13-1, the associated SS/PBCH block is not located according to NOTE 12 of Table 5.4.3.3-1 in [8-1, TS 38.101-1].

For operation with shared spectrum channel access in FR2-2 and for operation without shared spectrum channel access, a UE assumes that the offset in Tables 13-0 through 13-10A is defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, after puncturing if any [4, TS 38.211]. The SCS of the CORESET for Type0-PDCCH CSS set is provided by subCarrierSpacingCommon for FR1 and FR2-1 and same as the SCS of the corresponding SS/PBCH block for FR2-2. In Tables 13-7, 13-8, and 13-10, k_{SSB} is defined in [4, TS 38.211].

For operation without shared spectrum channel access and for the SS/PBCH block and CORESET multiplexing pattern 1, a UE monitors PDCCH in the Type0-PDCCH CSS set over two slots. For SS/PBCH block with index i, the UE determines an index of slot n₀ as

$${n}_{0} = ( O \cdot {2}^{μ} + ⌊ i \cdot M ⌋ ) mod {N}_{slot}^{frame , μ}$$

that is in a frame with system frame number (SFN) SFN_{C} satisfying

$${SFN}_{c} mod 2 = 0 if ⌊ ( O \cdot {2}^{μ} + ⌊ i \cdot M ⌋ ) / {N}_{slot}^{frame , μ} ⌋ mod 2 = 0 ,$$

or in a frame with SFN satisfying

$${SFN}_{c} mod 2 = 1 if ⌊ ( O \cdot {2}^{μ} + ⌊ i \cdot M ⌋ ) / {N}_{slot}^{frame , μ} ⌋ mod 2 = 1$$

where μ∈{0,1,2,3,5,6} based on the SCS for PDCCH receptions in the CORESET [4, TS 38.211].
For μ∈{0, 1, 2, 3} and for a SS/PBCH block index i, the two slots including the associated Type0-PDCCH monitoring occasions are slots n₀ and n₀+1. M, O, and the index of the first symbol of the CORESET in slots n₀ and n₀+1 are provided by Table 13-11 and Table 13-12.
For μ=5 and for a SS/PBCH block index i, the two slots including the associated Type0-PDCCH monitoring occasions are slots n₀ and n₀+4. M, O, and the index of the first symbol of the CORESET in slots n₀ and n₀+4 are provided by Table 13-12A, where X=1.25.
For μ=6 and for a SS/PBCH block index i, the two slots including the associated Type0-PDCCH monitoring occasions are slots n₀ and n₀+8. M, O, and the index of the first symbol of the CORESET in slots n₀ and n₀+8 are provided by Table 13-12A, where X=0.625.

For operation without shared spectrum channel access and for the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For a SS/PBCH block with index i, the UE determines the slot index n_{c} and SFN_{c} based on parameters provided by Tables 13-13 through 13-15A.

If a UE detects a first SS/PBCH block and determines that a CORESET for Type0-PDCCH CSS set is not present, and for 24≤k_{SSB}≤29 for FR1 or for 12≤k_{SSB}≤13 for FR2, the UE may determine the nearest (in the corresponding frequency direction) global synchronization channel number (GSCN) of a second SS/PBCH block having a CORESET for an associated Type0-PDCCH CSS set as

$${N}_{GSCN}^{Reference} + {N}_{GSCN}^{Size} \cdot {N}_{GSCN}^{Offset} \cdot {N}_{GSCN}^{Reference}$$

is the GSCN of the first SS/PBCH block S,

$${N}_{GSCN}^{Size} = 1$$

### in FR1 and FR2-2,

$${N}_{GSCN}^{Size} = 3 in FR 2 - 2 , and {N}_{GSCN}^{Offset}$$

is a GSCN offset provided by Table 13-16 for FR1 and Table 13-17 for FR2. If the UE detects the second SS/PBCH block and the second SS/PBCH block does not provide a CORESET for Type0-PDCCH CSS set, as described in clause 4.1, the UE may ignore the information related to GSCN of SS/PBCH block locations for performing cell search.

If a UE detects a SS/PBCH block and determines that a CORESET for Type0-PDCCH CSS set is not present, and for k_{SSB}=31 for FR1 or for k_{SSB}=15 for FR2, the UE determines that there is no SS/PBCH block having an associated Type0-PDCCH CSS set within a GSCN range

$$[ {N}_{GSCN}^{Reference} - {N}_{GSCN}^{Start} , {N}_{GSCN}^{Reference} + {N}_{GSCN}^{End} ] \cdot {N}_{GSCN}^{Start} and {N}_{GSCN}^{End}$$

are respectively determined by controlResourceSetZero and searchSpaceZero in pdcch-ConfigSIB1. If the GSCN range is

$$[ {N}_{GSCN}^{Reference} , {N}_{GSCN}^{Reference} ] ,$$

block with a CORESET for an associated Type0-PDCCH CSS set on the detected SS/PBCH block.

If a UE does not detect any SS/PBCH block providing a CORESET for Type0-PDCCH CSS set, as described in clause 4.1, within a time period determined by the UE, the UE may ignore the information related to GSCN of SS/PBCH locations in performing cell search.

3GPP TS 38.331 states:

### 5.2.2.3.3 Request for on Demand System Information

The UE shall, while SDT procedure is not ongoing:
1> if SIB1 includes si-Schedulinginfo containing si-RequestConfigSUL and criteria to select supplementary uplink as defined in TS 38.321[3], clause 5.1.1 is met:
   2> trigger the lower layer to initiate the Random Access procedure on supplementary uplink in accordance with TS 38.321 [3] using the PRACH preamble(s) and PRACH resource(s) in si-RequestConfigSUL corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else if the UE is a RedCap UE and if initialUplinkBWP-RedCap is configured in UplinkConfigCommonSlB and if SIB1 includes si-Schedulinginfo containing si-RequestConfigRedCap and criteria to select normal uplink as defined in TS 38.321[3], clause 5.1.1 is met:
   2> trigger the lower layer to initiate the Random Access procedure on normal uplink in accordance with TS 38.321 [3] using the PRACH preamble(s) and PRACH resource(s) in si-RequestConfigRedcap corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else:
   2> if the UE is not a RedCap UE and if SIB1 includes si-Schedulinginfo containing si-RequestConfig and criteria to select normal uplink as defined in TS 38.321[3], clause 5.1.1 is met; or
   2> if the UE is a RedCap UE and if initialUplinkBWP-RedCap is not configured in UplinkConfigCommonSlB and if SIB1 includes si-Schedulinginfo containing si-RequestConfig and criteria to select normal uplink as defined in TS 38.321[3], clause 5.1.1 is met:
      3> trigger the lower layer to initiate the Random Access procedure on normal uplink in accordance with TS 38.321 [3] using the PRACH preamble(s) and PRACH resource(s) in si-RequestConfig corresponding to the SI message(s) that the UE requires to operate within the cell, and for which si-BroadcastStatus is set to notBroadcasting;
      3> if acknowledgement for SI request is received from lower layers:
         4> acquire the requested SI message(s) as defined in clause 5.2.2.3.2, immediately;
   2> else:
      3> apply the default L1 parameter values as specified in corresponding physical layer specifications except for the parameters for which values are provided in SIB1;
      3> apply the default MAC Cell Group configuration as specified in 9.2.2;
      3> apply the timeAlignmentTimerCommon included in SIB1;
      3> apply the CCCH configuration as specified in 9.1.1.2;
      3> initiate transmission of the RRCSystemInfoRequest message with rrcSystemInfoRequest in accordance with 5.2.2.3.4;
      3> if acknowledgement for RRCSysteminfoRequest message with rrcSysteminfoRequest is received from lower layers:
         4> acquire the requested SI message(s) as defined in clause 5.2.2.3.2, immediately;
1> if cell reselection occurs while waiting for the acknowledgment for SI request from lower layers:
   2> reset MAC;
   2> if SI request is based on RRCSysteminfoRequest message with rrcSysteminfoRequest:
      3> release RLC entity for SRBO.
NOTE: After RACH failure for SI request it is up to UE implementation when to retry the SI request.

### SI-RequestConfig

The IE SI-RequestConfig contains configuration for Msg1 based SI request.

SI-RequestConfig information element

-- TAG-SI-REQUESTCONFIG-START

| | |
|---|---|
| SI-RequestConfig : := | SEQUENCE { |
| rach-OccasionsSI | SEQUENCE { |
| rach-ConfigSI | RACH-ConfigGeneric, |
| ssb-perRACH-Occasion | ENUMERATED {oneEighth, oneFourth, oneHalf, one, two, |
| four, eight, sixteen} | |
| } | |
| OPTIONAL, -- Need R | |
| si-RequestPeriod | ENUMERATED {one, two, four, six, eight, ten, twelve, |
| sixteen} OPTIONAL , -- Need R | |
| si-RequestResources | SEQUENCE (SIZE (1..maxSI-Message)) OF SI-RequestResources |
| } | |
| SI-RequestResources : := | SEQUENCE { |
| ra-PreambleStartIndex | INTEGER (0..63), |
| ra-AssociationPeriodIndex | INTEGER (0..15) |
| OPTIONAL, -- Need R | |
| ra-ssb-OccasionMaskIndex | INTEGER (0..15) |
| OPTIONAL, -- Need R | |
| } | |

-- TAG-SI-REQUESTCONFIG-STOP

···· ASN1STOP

### 5.2.2.3.1 Acquisition of MIB and SIB1

The UE shall:
1> apply the specified BCCH configuration defined in 9.1.1.1;
1> if the UE is in RRC_IDLE or in RRC_INACTIVE; or
1> if the UE is in RRC_CONNECTED while T311 is running:
   2> acquire the MIB, which is scheduled as specified in TS 38.213 [13];
   2> if the UE is unable to acquire the MIB;
      3> perform the actions as specified in clause 5.2.2.5;
   2> else:
      3> perform the actions specified in clause 5.2.2.4.1.
1> if the UE is in RRC_CONNECTED with an active BWP with common search space configured by searchSpaceSIB1 and pagingSearchSpace and has received an indication about change of system information; or
1> if the UE is in RRC_CONNECTED with an active BWP with common search space configured by searchSpaceSIB1 and the UE has not stored a valid version of a SIB or posSIB, in accordance with clause 5.2.2.2.1, of one or several required SIB(s) or posSIB(s) in accordance with clause 5.2.2.1, and, UE has not acquired SIB1 in current modification period; or
1> if the UE is in RRC_CONNECTED with an active BWP with common search space configured by searchSpaceSIB1, and, the UE has not stored a valid version of a SIB or posSIB, in accordance with clause 5.2.2.2.1, of one or several required SIB(s) or posSIB(s) in accordance with clause 5.2.2.1, and, si-BroadcastStatus for the required SIB(s) or posSI-BroadcastStatus for the required posSIB(s) is set to notbroadcasting in acquired SIB1 in current modification period; or
1> if the UE is in RRC_IDLE or in RRC_INACTIVE; or
1> if the UE is in RRC_CONNECTED while T311 is running:
   2> if ssb-SubcarrierOffset indicates SIB1 is transmitted in the cell (TS 38.213 [13]) and if SIB1 acquisition is required for the UE:
      3> acquire the SIB1, which is scheduled as specified in TS 38.213 [13];
      3> if the UE is unable to acquire the SIB1:
         4> perform the actions as specified in clause 5.2.2.5;
      3> else:
         4> upon acquiring SIB1, perform the actions specified in clause 5.2.2.4.2.
   2> else if SIB1 acquisition is required for the UE and ssb-SubcarrierOffset indicates that SIB1 is not scheduled in the cell:
      3> perform the actions as specified in clause 5.2.2.5.

### 5.2.2.2.2 SI Change Indication and PWS Notification

A modification period is used, i.e. updated SI message (other than SI message for ETWS, CMAS, positioning assistance data, and some NTN-specific information as specified in the field descriptions) is broadcasted in the modification period following the one where SI change indication is transmitted. The modification period boundaries are defined by SFN values for which SFN mod m=0, where m is the number of radio frames comprising the modification period. The modification period is configured by system information. If H-SFN is provided in SIB1, and UE is configured with eDRX, modification period boundaries are defined by SFN values for which (H-SFN*1024+SFN) mod m=0.

For UEs in RRC_IDLE or RRC_INACTIVE configured to use an IDLE eDRX cycle longer than the modification period, an eDRX acquisition period is defined. The boundaries of the eDRX acquisition period are determined by H-SFN values for which H-SFN mod 1024=0.

The UE receives indications about SI modifications and/or PWS notifications using Short Message transmitted with P-RNTI over DCI (see clause 6.5). Repetitions of SI change indication may occur within preceding modification period or within preceding eDRX acquisition period. SI change indication is not applicable for SI messages containing posSIBs.

UEs in RRC_IDLE or in RRC_INACTIVE while SDT procedure is not ongoing shall monitor for SI change indication in its own paging occasion(s) that the UE monitors as specified in TS 38.304 [20]. UEs in RRC_CONNECTED shall monitor for SI change indication in any paging occasion at least once per modification period if the UE is provided with common search space, including pagingSearchSpace, searchSpaceSIB1 and searchSpaceOtherSysteminformation, on the active BWP to monitor paging, as specified in TS 38.213 [13], clause 13.

UEs in RRC_INACTIVE while SDT procedure is ongoing shall monitor for SI change indication in any paging occasion at least once per modification period, if the initial downlink BWP on which the SDT procedure is ongoing is associated with a CD-SSB.

During a modification period where ETWS or CMAS transmission is started or stopped, the SI messages carrying the posSIBs scheduled in posSchedulingInfoList may change, so the UE might not be able to successfully receive those posSIBs in the remainder of the current modification period and next modification period according to the scheduling information received prior to the change.

ETWS or CMAS capable UEs in RRC_IDLE or in RRC_INACTIVE while SDT procedure is not ongoing shall monitor for indications about PWS notification in its own paging occasion(s) that the UE monitors as specified in TS 38.304 [20]. ETWS or CMAS capable UEs in RRC_CONNECTED shall monitor for indication about PWS notification in any paging occasion at least once every defaultPagingCycle if the UE is provided with common search space, including pagingSearchSpace, searchSpaceSIB1 and searchSpaceOtherSysteminformation, on the active BWP to monitor paging.

ETWS or CMAS capable UEs in RRC_INACTIVE while SDT procedure is ongoing shall monitor for indication about PWS notification in any paging occasion at least once every defaultPagingCycle, if the initial downlink BWP on which the SDT procedure is ongoing is associated with a CD-SSB.

For Short Message reception in a paging occasion, the UE monitors the PDCCH monitoring occasion(s) for paging as specified in TS 38.304 [20] and TS 38.213 [13].

A L2 U2N Remote UE is not required to monitor paging occasion for SI modifications and/or PWS notifications. It obtains the updated system information and SIB6/7/8 from the connected L2 U2N Relay UE as defined in clause 5.8.9.9.3.

If the UE receives a Short Message, the UE shall:
1> if the UE is ETWS capable or CMAS capable, the etwsAndCmaslndication bit of Short Message is set, and the UE is provided with searchSpaceSIB1 and searchSpaceOtherSystemInformation on the active BWP or the initial BWP:
   2> immediately re-acquire the SIB1;
   2> if the UE is ETWS capable and si-SchedulingInfo includes scheduling information for SIB6:
      3> acquire SIB6, as specified in clause 5.2.2.3.2, immediately;
   2> if the UE is ETWS capable and si-SchedulingInfo includes scheduling information for SIB7:
      3> acquire SIB7, as specified in clause 5.2.2.3.2, immediately;
   2> if the UE is CMAS capable and si-SchedulingInfo includes scheduling information for SIB8:
      3> acquire SIB8, as specified in clause 5.2.2.3.2, immediately; NOTE: In case SIB6, SIB7, or SIB8 overlap with a measurement gap it is left to UE implementation how to immediately acquire SIB6, SIB7, or SIB8.
1> if the UE does not operate an IDLE eDRX cycle longer than the modification period and the systemInfoModification bit of Short Message is set:
   2> apply the SI acquisition procedure as defined in clause 5.2.2.3 from the start of the next modification period;
1> if the UE operates an IDLE eDRX cycle longer than the modification period and the systemInfoModification-eDRX bit of Short Message is set:
   2> apply the SI acquisition procedure as defined in clause 5.2.2.3 from the start of the next eDRX acquisition period boundary.

Network energy saving is introduced to save power from base station perspective. Energy could be saved by reducing the transmission/reception occasion(s) in time domain. For example, during a period of time that no transmission/reception is performed. The corresponding hardware component(s) could be turn off completely (e.g. go to deep sleep) so that power consumption is reduced. Therefore, from power saving perspective, it would be more preferred to perform/finish transmission/reception within a certain period (e.g. a condensed period) and turn off transmission reception outside the certain period (e.g. for a longer period of time). There could be a trade-off that larger latency would be induced since the opportunities to transmit/receive is reduced. Common signal could be a source of an always turn-on signal irrespective of whether there is ongoing traffic.

For example, common signal (e.g. SSB, SS/PBCH block, SIB1, SIB(s), paging, PRACH) is broadcasted and/or could be used for all UEs in the cell, e.g. including UE not yet access the cell. Therefore, reducing the transmission/reception of common signal would become an attractive solution to network energy saving. More details regarding network energy saving is provided in 3GPP RAN1 #116bis Chairman's note as follows:

### 3 Justification

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. XR), networks are being denser, use more antennas, larger bandwidths and more frequency bands. The environmental impact of 5G needs to stay under control, and novel solutions to improve network energy savings need to be developed.

Energy consumption has become a key part of the operators' OPEX. According to the report from GSMA [1], the energy cost on mobile networks accounts for ~23% of the total operator cost. Most of the energy consumption comes from the radio access network and in particular from the Active Antenna Unit (AAU), with data centres and fibre transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

During the study in the SI phase [2], the network energy consumption model for the base station (BS) was defined including the reference configurations for FR1 TDD/FDD and FR2, the deep/light/micro sleep power states with corresponding relative power, transition time and energy consumption among different power states based on two types of BS categories, and the scaling rules for the active DL/UL power states considering BS power split by a static part of power and a dynamic part of power with the latter part reflecting the dynamic power consumption with respect to transmission/reception resource configurations in time, frequency, spatial and power domains. In addition, evaluation methodology and assumptions were achieved to study and evaluate the network energy saving gains for potential techniques with respect to other KPI including UPT, access delay, UE power consumption, etc.

Based on the agreed BS energy consumption model, and the evaluation methodology and assumptions, potential network energy saving techniques in various domains were evaluated with respect to the energy saving gains and the corresponding performance impact considering the above KPIs. The studied techniques are classified into time, frequency, spatial and power domains, and the technical descriptions as well as the legacy UE and specification impacts are summarized in the technical report [2]. The techniques in time and frequency domains mainly aim to reduce the power consumption for dynamic part by trying to shutdown more symbols on one or more carriers to achieve BS micro sleep, and even the static power part by enlarging the interval between the contiguous active transmission/reception occasions to achieve BS light/deep sleep. The techniques in spatial and power domains mainly aim to reduce the power consumption of the TRX chains and PAs by trying to shutdown more spatial elements and/or reduce transmission power/power spectrum density, or increase the PA efficiency. As shown in Section 7 in TR 38.864 [2], some of the studied techniques are beneficial for network energy savings.

The Rel-18 work item on network energy savings for NR led to the specification of some of the techniques that were found beneficial in the study, primarily for RRC Connected, user specific signals and channels, and low load scenarios. The techniques specified in Rel-18 include SSB-less SCell operation for inter-band CA for FR1 and co-located cells, enhancement on cell DTX/DRX mechanism including the alignment of cell DTX/DRX and UE DRX in RRC_CONNECTED mode, inter-node information exchange on cell DTX/DRX, techniques in spatial and power domains to enable efficient adaptation of spatial elements as well as efficient adaptation of power offset values between PDSCH and CSI-RS, as well as mechanisms to prevent legacy UEs camping on cells adopting the Rel-18 NES techniques, CHO procedure enhancement(s), and inter-node beam activation and enhancements on restricting paging in a limited area, and the corresponding RRM/RF core requirements.

Some other techniques also found to be beneficial in the study were not yet specified in Rel-18. This Rel-19 work item aims to specify further network energy savings targeting the beneficial techniques studied in Rel-18, but yet unspecified, including on-demand SSB and on-demand SIB1 transmissions, as well as adaptation of common signal/channel transmissions.

GSMA, 5G energy efficiencies: Green is the new black, https://data.gsmaintelligence.com/api-web/v2/research-file-download?id=54165956&file=241120-5G-energy.pdf 3GPP TR 38.864 V18.1.0, Study on network energy savings for NR.

### 4 Objective

### 4.1 Objective of SI or Core Part WI or Testing Part WI

The objectives of the work item are the following:
Specify procedures and signaling method(s) to support on-demand SSB SCell operation for UEs in connected mode configured with CA, for both intra-/inter-band CA. [RAN1/2/3/4]
Specify triggering method(s) (select from UE uplink wake-up-signal using an existing signal/channel, cell on/off indication via backhaul, Scell activation/deactivation signaling)
Note1: On-demand SSB transmission can be used by UE for at least SCell time/frequency synchronization, L1/L3 measurements and SCell activation, and is supported for FR1 and FR2 in non-shared spectrum.
Study procedures and signaling method(s) to support on-demand SIB1 for UEs in idle/inactive mode, including: [RAN1/2/3]
Triggering method by uplink wake-up-signal using an existing signal/channel.
Wake-up-signal configuration provisioning to UE
Note: No modification of SSB will be discussed under this objective
Information exchange between gNBs at least for the configuration of wake-up signal, if necessary.
Checkpoint for normative work in RAN #105
Specify adaptation of common signal/channel transmissions. [RAN1/2/3/4]
Adaptation of SSB in time domain, e.g. adapting periodicity
Adaptation of PRACH in time domain
Study adaptation of PRACH in spatial domain, e.g. non-uniform PRACH resources per SSB, and specify if found beneficial
This study is to be done in 2Q′2024 only
Adaptation of paging occasions including confining the paging occasions in the time domain
Note: there shall be no paging latency increase
Note: there shall be no negative impact to legacy UEs, unless significant benefits are shown
Specify the corresponding core requirements, for the above features [RAN4].

To support on-demand SIB1 for an NES cell, a WUS (wake up signal) configuration could be provided by another cell (e.g. Cell A, which may operate normally and cover a similar coverage of NES cell). When/after acquiring WUS configuration of NES cell from Cell A, the UE could send a WUS (e.g. preamble) to NES cell to request On-demand SIB1. The UE could receive the corresponding response (e.g. RAR) and monitor SIB1, e.g. after the RAR response is received. There are also some discussions related to how to determine when and/or where to monitor PDCCH for SIB1, e.g. when to start monitoring and/or in which search space/CORESET to monitor. More details related to on-demand SIB1 are discussed in :RAN1 #116bis Chairman's note, RAN1 #117 Chairman's note, RAN1 #118 Chairman's note, RAN1 #118bis Chairman's note, and RAN1 #119 Chairman's note as follows:

### Agreement

For the further study of on-demand SIB1 for idle/inactive mode UE, RAN1 focuses its studies on the following cases:
Case 1: Option 1+A+X
Case 2: Option 1+B+X
Case 3: Option 2+B+Y
Where the options 1/2/A/B/X/Y are defined below:
On target cell of UL WUS transmission:
Option 1: UE transmits UL WUS to NES Cell
Option 2: UE transmits UL WUS to Cell A
On configuration provision for UL WUS transmission
Option A: UE obtains the UL WUS configuration from NES Cell
Option B: UE obtains the UL WUS configuration from Cell A
On receiving of SIB1
Option X: UE receives on-demand SIB1 from NES Cell
Option Y: UE receives on-demand SIB1 from Cell A

### Agreement

RAN1 to further study the following UE operation scenarios in the UL WUS design:
Scenario 1: UE requests SIB1 to camp on NES cell
Scenario 2: UE request SIB1 to perform random access procedure to make RRC connection to
NES cell
Companies to consider the following for future meetings
Option 1: SIB1 monitoring occasions within a time window
FFS: The starting time and duration of the time window
FFS: Interval between two SIB1 monitoring occasions in the time window
FFS: How gNB informs UE the details related to the time window
Option 2: Periodic SIB1 monitoring occasions until gNB turns off the SIB1 transmission
FFS: The staring time of the SIB1 monitoring occasions
FFS: How gNB informs UE the SIB1 transmission is turned off
FFS: How gNB informs the UE the details related to periodicity
Other options are not precluded
FFS: Further details on SIB1 monitoring occasions

### Agreement

At least for Case-2: For further study of type 0 PDCCH monitoring occasions for on demand SIB1, after UE transmits the UL WUS in idle/inactive mode, RAN1 assumes following as a starting point:
Option 1: One or more type 0 PDCCH monitoring occasions for on demand SIB1 within a time window
FFS: How the search space zero configuration is provided (e.g. from searchSpaceZero in MIB or from a new search space that is indicated by UL-WUS configuration)
FFS: Details of the time window, including at least the starting time and duration
FFS: Whether/how to support transmission of on-demand SIB1 with the association with SSB(s) based on a received UL-WUS
R1-2405371 FL summary 2 for on-demand SIB1 in idle/inactive mode Moderator (MediaTek)

### Agreement

From RAN1 point of view, the following is feasible. It is up to RAN2 to decide whether/how to support it.

At least for Case 2 (Option 1+B+X) design, a unified configuration format that can support both Option 2 (i.e. a UL-WUS configuration applies to multiple NES cells) and Option 3 (i.e. a UL-WUS configuration applies to a single NES cell).

### Agreement

RAN1 assumes the UE is expected to receive the RAR responding to the preamble transmission for Msg1-based on-demand SIB1 procedure, as the baseline.

### Agreement

At least for Case-2: For further work on type 0 PDCCH monitoring occasions for on demand SIB1, on the starting time and duration of the time window of type 0 PDCCH monitoring occasions, RAN1 to down select from the following two options:
Option 1: starting time and duration are indicated in RAR of the UL-WUS transmission
Option 2: starting time and duration are indicated in the UL WUS configuration

### Agreement

At least for Case-2: For further work on type 0 PDCCH monitoring occasions for on demand SIB1, on reference time point to determine the window starting time, RAN1 to down select from the following two options:
Option 1: The reference time point is defined based on the RAR reception time of the UL-WUS transmission
FFS: Definition of RAR reception time
Option 2: The reference time point is defined based on the UL-WUS transmission time
Option 3: The reference time point is defined based on the RAR window of the UL-WUS transmission

### Agreement

For Case-2: For type 0 PDCCH monitoring occasions for on demand SIB1, on how the search space zero configuration is provided, RAN1 to down select from the following options:
Option 1: searchSpaceZero for on-demand SIB1 is provided from MIB on NES cell
Option 2: searchSpaceZero for on-demand SIB1 is provided from UL WUS configuration
Option 3: searchSpaceZero for on-demand SIB1 is provided from the RAR of UL WUS.
Combination of multiple options is not precluded.

### Agreement

For type 0 PDCCH monitoring occasions of on demand SIB1, searchSpaceZero and controlResourceSetZero for on-demand SIB1 are provided from UL WUS configuration if SSB on NES cell is on sync raster and K_SSB is not equal to 30 in FR1 or 14 in FR2.

### Agreement

For The repetition periodicity of SIB1 within the time window of on-demand SIB1:
Up to NW implementation (no change to existing specification)

### Agreement

RAN1 to discuss the contents of RAR in response to UL WUS using the legacy RAR for OSI as a starting point

### Agreement

Search space for RAR in response to UL WUS on a NES Cell can be provided by the UL WUS configuration. If not, follow the search space zero for the NES Cell.

### Agreement

CORESET0 of NES cell is used for RAR CORESET of that NES cell.

### Agreement

At least for the case where SSB is transmitted on sync-raster, the indication of the quantity K_SSB (defined in TS 38.211 as subcarrier offset from subcarrier 0 in common resource block

$${N}_{CRB}^{SSB}$$

to the lowest-numbered subcarrier of the SS/PBCH block) is included in the UL-WUS configuration for FDD and TDD NES cell.

### Agreement

The reference time point to determine the window starting time for on-demand SIB1 is based on the RAR window for UL WUS wherein UE successfully received a RAR.

FFS: Use starting or ending slot of the RAR window as reference time

### Agreement

The duration of the time window for on-demand SIB1 is indicated in the UL WUS configuration.

### Unit of the Duration is in Slot

FFS: Starting time

R1-2410679 FL summary 3 for on-demand SIB1 in idle/inactive mode Moderator (MediaTek)

### Agreement

On how to use PDCCH-ConfigSIB1 for R19 NES-capable UE in MIB of NES Cell when K_SSB=30 in FR1 or K_SSB=14 in FR2 on NES cell if SSB of NES cell is on the sync raster, down-select from the following options:
Option 1: Use it to indicate frequency assistance information to search SSB for Cell A
FFS: Details on the range/granularity of the frequency assistance information
FFS: Potential impact to RAN3
Option 2: Use it to indicate searchSpaceZero and controlResourceSetZero of OD-SIB1
Option 3: Above feature is not supported.

R1-2410680 FL summary 4 for on-demand SIB1 in idle/inactive mode Moderator (MediaTek)

### Agreement

At least the contents of RAR in response to SI request are included in RAR in response to UL WUS

As discussed above, UE could initiate a random access procedure to request SIB1. The UE would transmit a preamble to a (Network Energy Savings (NES)) cell. The UE monitor Re-Authorization Request (RAR) in response to transmission of the preamble within a RAR window. The UE could monitor Physical Downlink Control Channel (PDCCH) for SIB1 after reception of the corresponding RAR. The UE could receive configuration related to search space for SIB1 and/or duration of monitoring PDCCH for SIB1 (e.g. a length of time window to monitor PDCCH for SIB1), e.g. from WUS configuration. However, UE still requires to determine a starting time of monitoring PDCCH for SIB1. The starting time could be determined based on a reference time point/reference time. The reference time point/reference time could be determined based on RAR and/or a RAR window. The reference time point/reference time could be a starting slot of the RAR window, an ending slot of the RAR window, and/or a slot UE receiving the RAR. A starting time of monitor PDCCH for SIB1 could be determined with respect to and/or based on the reference time (point). For example, there could be a time offset between the starting time of monitoring PDCCH for SIB1 and the reference time point.

A value of the time offset could be predefined/fixed and/or indicated by the base station (e.g. via Wake Up Signal (WUS) configuration and/or RAR). The UE could determine a proper stating time of monitoring PDCCH of SIB1 (e.g. based on the reference time point and/or time offset value). However, it is possible that the UE does not initiate a random access procedure, while still requires to monitor PDCCH for SIB1. For example, the UE would check a broadcasting status of SIB1 before initiating the random access procedure.

Another example could be system information status change (e.g. system information change or PWS (Public Warning System) notification). If UE receive an indication (e.g via the broadcasting status or system information status change) indicating that the cell would provide SIB (e.g. in the following or in a near future or in the following time window) and/or the cell would provide SIB1 on demand and/or SIB1 is currently being broadcasted, the UE would not initiate a random access procedure. On the other hand, if UE receives an indication (e.g via the broadcasting status indicating that the cell would not provide SIB (e.g. in the following or in a near future or in the following time window) and/or the cell would not provide SIB1 on demand and/or SIB1 is currently not broadcasting, the UE would initiate a random access procedure, e.g. to request (on-demand) SIB1.

However, for UE which does not initiate a random access procedure, there is no RAR and/or no RAR window. If the reference time (point) for monitoring PDCCH for SIB1 is determined based on RAR/RAR window, the UE which does not initiate a random access procedure could not determine the reference time (point). Such UE may not be able to determine a starting time for monitoring PDCCH for SIB1 and thus could not be able to acquire SIB1. When the OD-SIB1 is to be acquired due to system information status change (e.g. system information change or PWS notification), the UE would firstly send a UL WUS to request OD-SIB1 and receive OD-SIB1 after the corresponding RAR is received. Extra delay and/or signaling would then be required to finish the corresponding update.

A first general concept of this invention is to determine a first reference time (point) based on reception of a signal/indication and/or a time point different from RAR or irrelevant to RAR. The signal/indication could be a signal/indication indicating a broadcasting status or system information status change for a cell. The signal/indication could be a signal/indication indicating whether the cell would provide or update SIB/SIB1 (e.g. in the following or in a near future or in the following time window) or not and/or whether the cell would provide SIB1 on demand or not and/or whether SIB1 is currently being broadcasted/provided or not. The signal/indication could be an SSB. The signal/indication could be a WUS configuration.

A first time offset value used to determine a starting time for monitoring PDCCH for SIB1 with respect to the first reference time (point) could be different from a second time offset value with respect to a second reference time (point) based on RAR and/or RAR window. The first time offset value could be indicated by a first base station. The first time offset value could be indicated in a WUS configuration. The first time offset value could be indicated in SSB/MIB. The first time offset value could be fixed and/or predetermined and/or predefined and/or preconfigured.

The second time offset value could be indicated by a second base station. The first base station and the second base station could be a/the same base station. The first base station and the second base station could be different base stations.

The second time offset value could be indicated in a WUS configuration. The second time offset value could be indicated in RAR. The second time offset could be fixed and/or predetermined and/or predefined and/or preconfigured. The second time offset value could be different from the first offset value. The second time offset value could be the same as the first offset value.

The UE could determine whether to use the first reference time (point) or to use the second reference time (point) and/or whether to use the first time offset value or to use the second time offset value based on whether a random access procedure is initiated (e.g. to request on-demand SIB1) or not. The UE could use the first reference time (point) and/or to use the first time offset value to determine a starting time for monitoring PDCCH for SIB1 if/when a random access procedure is not initiated (e.g. to request on-demand SIB1). The UE could use the second reference time (point) and/or to use the second time offset value to determine a starting time for monitoring PDCCH for SIB1 if/when a random access procedure is initiated (e.g. to request on-demand SIB1).

A second general concept of this invention is to monitor RAR without initiating a random access procedure (e.g. to request o-demand SIB1) and/or without transmitting PRACH (while e.g. initiating a random access procedure). A UE could determine whether to initiate a random access procedure (e.g. to request on-demand SIB1) based on a broadcasting status of SIB1. A UE could determine whether to initiate a random access procedure (e.g. to request on-demand SIB1) based on whether the cell would provide SIB1 (e.g. in the following or in a near future or in the following time window) or not and/or whether the cell would provide SIB1 on demand or not and/or whether SIB1 is currently being broadcasted/provided or not.

A UE could initiate a random access procedure (e.g. to request on-demand SIB1) if/when the cell would not provide SIB1 (e.g. in the following or in a near future or in the following time window) and/or if/when the cell would not provide SIB1 on demand and/or if/when SIB1 is not currently being broadcasted. A UE may not initiate a random access procedure (e.g. to request on-demand SIB1) if/when the cell would provide SIB (e.g. in the following or in a near future or in the following time window) and/or if/when the cell would provide SIB1 on demand and/or if/when SIB1 is currently being broadcasted.

The UE could (directly) monitors PDCCH for RAR in a time window without initiating a random access procedure (e.g. to request on-demand SIB1). A UE could determine whether to transmit Physical Random Access Channel (PRACH) (e.g. to request on-demand SIB1) based on a broadcasting status of SIB1. A UE could determine whether to transmit PRACH (e.g. to request on-demand SIB1) based on whether the cell would provide SIB1 (e.g. in the following or in a near future or in the following time window) or not and/or whether the cell would provide SIB1 on demand or not and/or whether SIB1 is currently being broadcasted or not.

A UE could transmit PRACH (e.g. to request on-demand SIB1) if/when the cell would not provide SIB1 (e.g. in the following or in a near future or in the following time window) and/or if/when the cell would not provide SIB1 on demand and/or if/when SIB1 is not currently being broadcasted. A UE may not transmit PRACH (e.g. to request on-demand SIB1) if/when the cell would provide SIB (e.g. in the following or in a near future or in the following time window) and/or if/when the cell would provide SIB1 on demand and/or if/when SIB1 is currently being broadcasted.

The UE could (directly) monitor PDCCH for RAR in a time window without transmitting PRACH (e.g. to request on-demand SIB1). The UE could (directly) monitor PDCCH for RAR in a time window prior to determines whether to initiate a random access procedure (e.g. to request on-demand SIB1). The UE (directly) monitors PDCCH for RAR without transmitting PRACH (e.g. to request on-demand SIB1).

An RAR could indicate a broadcasting status of SIB1. An RAR could indicate whether the cell would provide SIB1 (e.g. in the following or in a near future or in the following time window) or not and/or whether the cell would provide SIB1 on demand or not and/or whether SIB1 is currently being broadcasted or not.

A UE could determine whether to initiate a random access procedure (e.g. to request on-demand SIB1) based on whether the cell would provide SIB1 (e.g. in the following or in a near future or in the following time window) or not and/or whether the cell would provide SIB1 on demand or not and/or whether SIB1 is currently being broadcasted or not. If/when RAR indicates the cell would provide SIB1 (e.g. in the following or in a near future or in the following time window) and/or indicates the cell would provide SIB1 on demand and/or indicates SIB1 is currently being broadcasted, the UE (directly) monitors PDCCH for SIB1. The UE could determine starting time to monitor PDCCH for SIB1 based on the RAR and/or a time window to monitor RAR. The RAR is an RAR indicating a broadcasting status. The RAR is not monitored in response to a transmission of PRACH. The RAR is monitored without a transmission of PRACH.

The time window could start based on a timing the UE determines to request SIB1. The time window could start when the UE determines to request SIB1. If/when RAR indicates the cell would not provide SIB1 (e.g. in the following or in a near future or in the following time window) and/or indicates the cell would not provide SIB1 on demand and/or indicates SIB1 is not currently being broadcasted, the UE would initiate a random access procedure (e.g. to request on-demand SIB1). If/when the UE does not detect RAR during the time window, the UE would initiate a random access procedure (e.g. to request on-demand SIB1). The UE would transmit a PRACH, e.g. to request SIB1.

In response to transmission of the PRACH, the UE could monitor an (another/second) RAR within a (second) time window. After receiving the RAR, the UE could determine starting time to monitor PDCCH for SIB1 based on the (second) RAR and/or based on the (second) time window. The second RAR is in response to a PRACH transmission. A UE could determine whether to initiate a random access procedure (e.g. to request on-demand SIB1) based on whether the cell would provide SIB (e.g. in the following or in a near future or in the following time window) or not and/or whether the cell would provide SIB1 on demand or not and/or whether SIB1 is currently being broadcasted or not.

A signal different from RAR could indicate a broadcasting status of SIB1. A signal different from RAR could indicates whether the cell would provide SIB (e.g. in the following or in a near future or in the following time window) or not and/or whether the cell would provide SIB1 on demand or not and/or whether SIB1 is currently being broadcasted or not. The signal different from RAR could be one or more of an SSB and/or a WUS configuration. The RAR could be monitored without a transmission of PRACH. The time window could start based on a timing of signal different from RAR. The time window could start when the UE receives the signal other than RAR. The time window could start based on an indication indicating whether the cell would provide SIB (e.g. in the following or in a near future or in the following time window) or not and/or whether the cell would provide SIB1 on demand or not and/or whether SIB1 is currently being broadcasted or not. The time window could start when/if the UE receives the indication.

The UE could determine a stating time to monitor PDCCH for SIB1 based on the RAR and/or time window to monitor RAR. If/when the signal different from RAR indicates the cell would not provide SIB1 (e.g. in the following or in a near future or in the following time window) and/or indicates the cell would not provide SIB1 on demand and/or indicates SIB1 is not currently being broadcasted, the UE would initiate a random access procedure (e.g. to request on-demand SIB1).

In one embodiment, a UE could receive an indication of broadcasting status or system information status change. The UE could receive an indication indicating whether the cell would provide or update SIB/SIB1 (e.g. in the following or in a near future or in the following time window) or not and/or whether the cell would provide SIB1 on demand or not and/or whether SIB1 is currently being broadcasted or not. The UE could determine a starting time to monitor PDCCH for SIB1 based on the indication. The UE could determine a reference time point for starting time to monitor PDCCH for SIB1 based on the indication. The UE could determine a time offset (value) for starting time to monitor PDCCH for SIB1 based on the indication.

The starting time to monitor PDCCH for SIB1 is determined based on a reference time point and/or a time offset (value). The starting time to monitor PDCCH for SIB1 is a slot which is X slots after the reference time point, wherein X is a time offset value. The starting time to monitor PDCCH for SIB1 is determined based on a slot which is X slots after the reference time point, wherein X is a time offset value.

The UE could start monitoring PDCCH for SIB/SIB1 from a first starting time if/when the indication indicates the cell would provide or update SIB/SIB1 (e.g. in the following or in a near future or in the following time window) and/or the cell would provide SIB1 on demand and/or SIB1 is currently being broadcasted. The UE could start monitoring PDCCH for SIB/SIB1 from a first starting time if/when the UE acquire SIB1 in response to reception of the indication. The UE could start monitoring PDCCH for SIB/SIB1 from a second starting time if/when the indication indicates the cell would not provide/update SIB/SIB1 (e.g. in the following or in a near future or in the following time window) and/or the cell would not provide SIB1 on demand and/or SIB1 is not currently being broadcasted. The UE could start monitoring PDCCH for SIB/SIB1 from a second starting time if/when the UE acquire SIB1 not in response to reception of the indication.

The first starting time could be determined based on the indication. The indication could also carry or indicate information for determining starting time to monitor PDCCH for SIB1. The first starting time could be determined based on a timing (e.g. slot) when the indication is received. The first starting time could be determined based on an SSB. The first starting time could be determined based on an WUS configuration. The first starting time could be determined based on a predefined timing. The first starting time could be determined based on a radio frame(number). The first starting time may not be determined based on RAR and/or a time window for RAR.

The second starting time could be determined based on RAR and/or a time window for RAR. The second starting time could be determined based on WUS configuration. The reference time point could be a first reference time point if/when the indication indicates the cell would not provide SIB1 (e.g. in the following or in a near future or in the following time window) and/or the cell would not provide SIB1 on demand and/or SIB1 may not be currently being broadcasted. The reference time point could be a second reference time point if/when the indication indicates the cell would provide SIB1 (e.g. in the following or in a near future or in the following time window) and/or the cell would provide SIB1 on demand and/or SIB1 is currently being broadcasted.

The second reference time point could be based on RAR and/or a time window of RAR. The second reference point could be the first slot (e.g. starting slot) of a time window for RAR. The second reference point could be the last slot (e.g. ending slot) of a time window for RAR.

The first reference time point could be a slot where the indication is received. The first reference time point could be based on a slot where the indication is received. The first reference time point could be based on a Synchronization Signal Block (SSB). The first reference time point could be based on slot comprising a SSB. The first reference time point could be based on slot receiving an SSB. The first reference time point is a slot receiving an SSB. The first reference time point could be based on a WUS configuration. The first reference time point could be based on slot receiving a WUS configuration. The first reference time point could be indicated by the indication. The first reference time point could be indicated by an SSB. The first reference time point could be indicated by a WUS configuration.

The time offset (value) could be with a first time offset value if/when the indication indicates the cell would not provide/update SIB/SIB1 (e.g. in the following or in a near future or in the following time window) and/or the cell would not provide SIB1 on demand and/or SIB1 is not currently being broadcasted. The time offset (value) could be with a second time offset value if/when the indication indicates the cell would provide or update SIB/SIB1 (e.g. in the following or in a near future or in the following time window) and/or the cell would provide SIB1 on demand and/or SIB1 is currently being broadcasted. The second time offset value could be indicated by a WUS configuration. The second time offset value could be indicated by a RAR. The first time offset value could be indicated by a WUS configuration. The first time offset value could be indicated by an SSB. The first time offset value could be indicated by the indication. The first time offset value could be indicated by a base station. The first time offset value could be fixed. The first time offset value could be predefined, predetermined, or preconfigured.

In another embodiment, a UE could monitor PDCCH for a (first) random access response (RAR) irrespective of whether a random access procedure is initiated or not and/or irrespective of whether a PRACH is transmitted or not. The UE could monitor (a PDCCH for) a random access response (even) when/if a random access procedure is not initiated. The UE could monitor (a PDCCH for) a random access response (even) when/if a PRACH is not transmitted. The UE could monitor a random access response for an indication indicating a status of SIB1. The UE could monitor a random access response for determine a starting time to monitor PDCCH for SIB1. The UE could monitor a random access response in response to reception of an indication indicating a status of SIB1. The UE could monitor a random access response in response to an indication indicating the cell would provide SIB1 (e.g. in the following or in a near future or in the following time window) and/or indicating the cell would provide SIB1 on demand and/or indicating SIB1 is currently being broadcasted. The UE could monitor a random access response when/if an indication indicating the cell would provide SIB1 (e.g. in the following or in a near future or in the following time window) and/or when/if the cell would provide SIB1 on demand and/or when/if SIB1 is currently being broadcasted.

The UE could initiate a random access procedure without transmitting PRACH when/if an indication indicating the cell would provide SIB1 (e.g. in the following or in a near future or in the following time window) and/or when/if the cell would provide SIB1 on demand and/or when/if SIB1 is currently being broadcasted. The UE may not initiate a random access procedure (e.g. to request SIB1) when/if an indication indicating the cell would provide SIB1 (e.g. in the following or in a near future or in the following time window) and/or when/if the cell would provide SIB1 on demand and/or when/if SIB1 is currently being broadcasted. The UE could initiate a random access procedure (e.g. to request SIB1) when/if an indication indicating the cell would not provide SIB1 (e.g. in the following or in a near future or in the following time window) and/or when/if the cell would not provide SIB1 on demand and/or when/if SIB1 is not currently being broadcasted.

The UE could transmit PRACH during the random access procedure (e.g. to request SIB1). The UE could monitor a (second) RAR during the random access procedure (e.g. to request SIB1). The UE could monitor a RAR response to a PRACH transmission (e.g. to request SIB1). The indication could indicate a broadcasting status for a cell. The indication could indicate whether the cell would provide SIB1 (e.g. in the following or in a near future or in the following time window) or not and/or whether the cell would provide SIB1 on demand or not and/or whether SIB1 is currently being broadcasted or not.

The RAR could indicate a broadcasting status for a cell. The RAR could indicate whether the cell would provide SIB1 (e.g. in the following or in a near future or in the following time window) or not and/or whether the cell would provide SIB1 on demand or not and/or whether SIB1 is currently being broadcasted or not. The indication could be indicated by RAR. The indication could be indicated by SSB. The indication could be indicated by a WUS configuration.

The starting time to monitor PDCCH for SIB1 could be determined based on the (first/second) RAR and/or a time window for (monitoring) the (first/second) RAR. The starting time to monitor PDCCH for SIB1 could be determined based on a WUS configuration. A reference time point for determining starting time to monitor PDCCH for SIB1 could be determined based on the (first/second) RAR and/or a time window for (monitoring) the (first/second) RAR. A reference time point for determining starting time to monitor PDCCH for SIB1 could be indicated by the (first/second) RAR. A reference time point for determining starting time to monitor PDCCH for SIB1 is indicated by the indication. A reference time point for determining starting time to monitor PDCCH for SIB1 could be indicated by SSB or WUS configuration. A time offset for determining starting time to monitor PDCCH for SIB1 could be indicated by the (first/second) RAR. A time offset for determining starting time to monitor PDCCH for SIB1 could be indicated by the indication. A time offset for determining starting time to monitor PDCCH for SIB1 could be indicated by SSB or WUS configuration.

Throughout the invention, the invention describes behavior or operation of a single serving cell unless otherwise noted.

Throughout the invention, the invention describes behavior or operation of multiple serving cells unless otherwise noted.

Throughout the invention, the invention describes behavior or operation of a single bandwidth part unless otherwise noted.

Throughout the invention, a base station configures multiple bandwidth parts to the UE unless otherwise noted.

Throughout the invention, a base station configures a single bandwidth part to the UE unless otherwise noted.

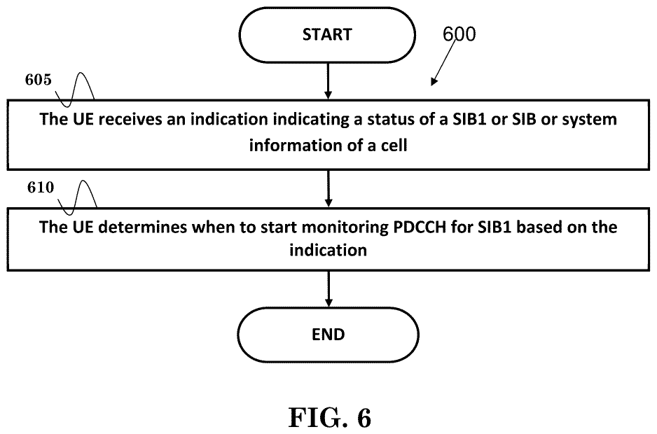

FIG. 6 is a flow chart 600 for a User Equipment (UE). In step 605, the UE receives an indication indicating a status of a SIB1 or SIB or system information of a cell. In step 610, the UE determines when to start monitoring PDCCH for SIB1 based on the indication.

In one embodiment, the indication could indicate a broadcasting status of SIB1 or SIB or system information. The method of claim 1 to 2, the indication could indicate whether the cell would provide or update SIB/SIB1/system information (e.g. in the following or in a near future or in the following time window) or not. The indication could indicate the cell would provide SIB1 on demand or not. The indication could indicate whether SIB1 is currently being broadcasted or not.

In one embodiment, the UE could determine to start monitoring PDCCH for SIB1 based on a RAR and or a time window for monitoring an RAR if/when the indication indicates the cell would not provide or update SIB/SIB1/system information (e.g. in the following or in a near future or in the following time window), or the UE could determine to start monitoring PDCCH for SIB1 based on a RAR and or a time window for monitoring an RAR if/when the UE acquires SIB1 not in response to reception of the indication. The UE could determine to start monitoring PDCCH for SIB1 based on a RAR and or a time window for monitoring an RAR if/when the indication indicates the cell would not provide SIB1 on demand. The UE could determine to start monitoring PDCCH for SIB1 based on a RAR and or a time window for monitoring an RAR if/when the indication indicates SIB1 is not currently being broadcasted/provided.

The UE could determine to start monitoring PDCCH for SIB1 based on a timing indicated by the indication if/when the indication indicates the cell would provide or update SIB/SIB1/system information (e.g. in the following or in a near future or in the following time window), or the UE could determine to start monitoring PDCCH for SIB1 based on a timing indicated by the indication if/when the UE acquires SIB1 in response to reception of the indication. The UE could determine to start monitoring PDCCH for SIB1 based on a timing indicated by the indication if/when the indication indicates the cell would provide SIB1 on demand. The UE could determine to start monitoring PDCCH for SIB1 based on a timing indicated by the indication if/when the indication indicates SIB1 is not currently being broadcasted/provided.

The UE could determine to start monitoring PDCCH for SIB1 based on a timing that the indication is received if/when the indication indicates the cell would provide or update SIB/SIB1/system information (e.g. in the following or in a near future or in the following time window), or the UE could determine to start monitoring PDCCH for SIB1 based on a timing that the indication is received if/when the UE acquires SIB1 in response to reception of the indication. The UE could determine to start monitoring PDCCH for SIB1 based on a timing that the indication is received if/when the indication indicates the cell would provide SIB1 on demand. The UE could determine to start monitoring PDCCH for SIB1 based on a timing that the indication is received if/when the indication indicates SIB1 is not currently being broadcasted/provided.

The UE could determine to start monitoring PDCCH for SIB1 based on a predefined timing if/when the indication indicates the cell would provide or update SIB/SIB1/system information (e.g. in the following or in a near future or in the following time window), or the UE could determine to start monitoring PDCCH for SIB1 based on a predefined timing if/when the UE acquires SIB1 in response to reception of the indication. The UE could determine to start monitoring PDCCH for SIB1 based on a predefined timing if/when the indication indicates the cell would provide SIB1 on demand. The UE could determine to start monitoring PDCCH for SIB1 based on a predefined timing if/when the indication indicates SIB1 is not currently being broadcasted/provided.

The UE could determine to start monitoring PDCCH for SIB1 based on a WUS configuration if/when the indication indicates the cell would provide or update SIB/SIB1/system information (e.g. in the following or in a near future or in the following time window), or the UE could determine to start monitoring PDCCH for SIB1 based on a WUS configuration if/when the UE acquires SIB1 in response to reception of the indication. The UE could determine to start monitoring PDCCH for SIB1 based on a WUS configuration if/when the indication indicates the cell would provide SIB1 on demand. The UE could determine to start monitoring PDCCH for SIB1 based on a WUS configuration if/when the indication indicates SIB1 is not currently being broadcasted/provided.

The UE could determine to start monitoring PDCCH for SIB1 based on an SSB if/when the indication indicates the cell would provide/update SIB/SIB1/system information (e.g. in the following or in a near future or in the following time window), or the UE could determine to start monitoring PDCCH for SIB1 based on an SSB if/when the UE acquires SIB1 in response to reception of the indication. The UE could determine to start monitoring PDCCH for SIB1 based on an SSB if/when the indication indicates the cell would provide SIB1 on demand. The UE could determine to start monitoring PDCCH for SIB1 based on an SSB if/when the indication indicates SIB1 is not currently being broadcasted/provided.

Referring back to FIGS. 3 and 4, in one exemplary embodiment from the perspective of a UE. The UE 300 includes a program code 312 stored in the memory 310. The CPU 308 could execute program code 312 to enable the UE (i) to receive an indication indicating a status of a SIB1 or SIB or system information of a cell, and (ii) to determine when to start monitoring PDCCH for SIB1 based on the indication. Furthermore, the CPU 308 can execute the program code 312 to perform all of the above-described actions and steps or others described herein.

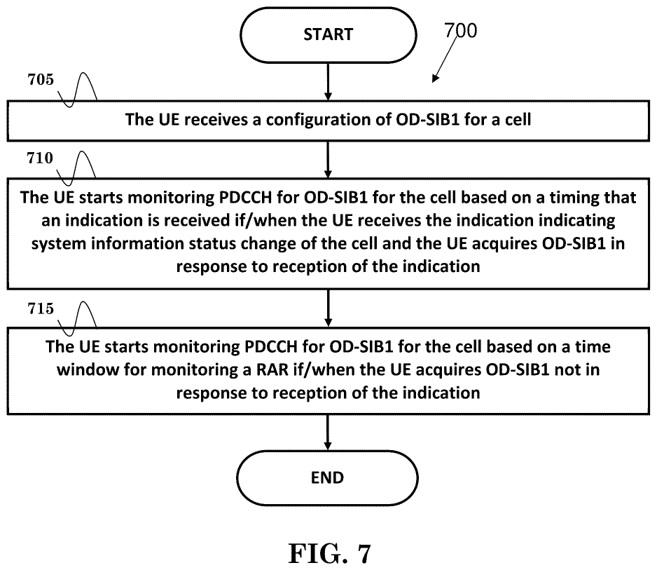

FIG. 7 is a flow chart 700 for a User Equipment (UE). In step 705, the UE receives a configuration of On-Demand System Information Block 1 (OD-SIB1) for a cell. In step 710, the UE starts monitoring Physical Downlink Control Channel (PDCCH) for OD-SIB1 for the cell based on a timing that an indication is received if/when the UE receives the indication indicating system information status change of the cell and the UE acquires OD-SIB1 in response to reception of the indication. In step 715, the UE starts monitoring PDCCH for OD-SIB1 for the cell based on a time window for monitoring a Random Access Response (RAR) if/when the UE acquires OD-SIB1 not in response to reception of the indication.

In one embodiment, the UE may start monitoring PDCCH for OD-SIB1 after the indication is received if/when the UE receives the indication indicating system information status change of the cell and the UE acquires OD-SIB1 in response to reception of the indication. The UE may start monitoring PDCCH for OD-SIB1 after a starting slot of time window for monitoring the RAR if/when the UE acquires OD-SIB1 not in response to reception of the indication. The UE may start monitoring PDCCH for OD-SIB1 after a time offset from a starting slot of time window for monitoring the RAR if/when the UE acquires OD-SIB1 not in response to reception of the indication.

In one embodiment, the RAR could be received in response to transmission of OD-SIB1 request. The UE may not initiate a random access procedure for requesting OD-SIB1 if/when the UE acquires OD-SIB1 in response to the reception of the indication. The UE may initiate a random access procedure for requesting OD-SIB1 if/when the UE acquires OD-SIB1 not in response to reception of the indication.

In one embodiment, system information status change could be one or more of system information change or public warning system (PWS) notification.

Referring back to FIGS. 3 and 4, in one exemplary embodiment from the perspective of a UE. The UE 300 includes a program code 312 stored in the memory 310. The CPU 308 could execute program code 312 to enable the UE (i) to receive a configuration of OD-SIB1 for a cell, (ii) to start monitoring PDCCH for OD-SIB1 for the cell based on a timing that an indication is received if/when the UE receives the indication indicating system information status change of the cell and the UE acquires OD-SIB1 in response to reception of the indication, and (iii) to starts monitoring PDCCH for OD-SIB1 for the cell based on a time window for monitoring a RAR if/when the UE acquires OD-SIB1 not in response to reception of the indication. Furthermore, the CPU 308 can execute the program code 312 to perform all of the above-described actions and steps or others described herein.

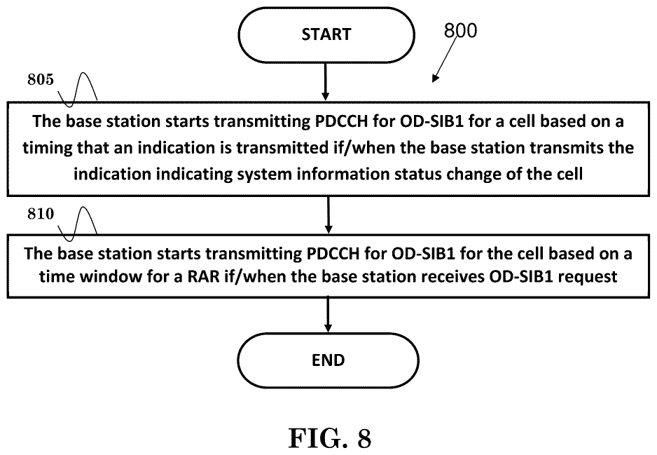

FIG. 8 is a flow chart 800 for a base station. In step 805, the base station starts transmitting Physical Downlink Control Channel (PDCCH) for On-Demand System Information Block 1 (OD-SIB1) for a cell based on a timing that an indication is transmitted if/when the base station transmits the indication indicating system information status change of the cell. In step 810, the base station starts transmitting PDCCH for OD-SIB1 for the cell based on a time window for a Random Access Response (RAR) if/when the base station receives OD-SIB1 request.

In one embodiment, the cell could be configured with OD-SIB1. The base station may start transmitting PDCCH for OD-SIB1 after the indication is transmitted if/when the base station transmits the indication indicating system information status change of the cell. The base station may start transmitting PDCCH for OD-SIB1 after a starting slot of time window for the RAR if/when the base station receives OD-SIB1 request. The base station may start transmitting PDCCH for OD-SIB1 after a time offset from a starting slot of time window for the RAR if/when the base station receives OD-SIB1 request.

In one embodiment, the RAR could be in response to reception of OD-SIB1 request. The OD-SIB1 could be transmitted without OD-SIB1 request from a UE if/when the base station transmits the indication indicating system information status change of the cell. The OD-SIB1 could be transmitted in response to OD-SIB1 request from a UE if/when the base station does not transmit the indication indicating system information status change of the cell.

In one embodiment, system information status change could be one or more of system information change or public warning system (PWS) notification.

Referring back to FIGS. 3 and 4, in one exemplary embodiment from the perspective of a base station. The UE 300 includes a program code 312 stored in the memory 310. The CPU 308 could execute program code 312 to enable the base station (i) to start transmitting Physical Downlink Control Channel (PDCCH) for On-Demand System Information Block 1 (OD-SIB1) for a cell based on a timing that an indication is transmitted if/when the base station transmits the indication indicating system information status change of the cell, and (ii) to start transmitting PDCCH for OD-SIB1 for the cell based on a time window for a Random Access Response (RAR) if/when the base station receives OD-SIB1 request. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
the UE receives a configuration of On-Demand System Information Block 1 (OD-SIB1) for a cell;
the UE starts monitoring Physical Downlink Control Channel (PDCCH) for OD-SIB1 for the cell based on a timing that an indication is received if the UE receives the indication indicating system information status change of the cell and the UE acquires OD-SIB1 in response to reception of the indication; and
the UE starts monitoring PDCCH for OD-SIB1 for the cell based on a time window for monitoring a Random Access Response (RAR) if the UE acquires OD-SIB1 not in response to reception of the indication.

2. The method of claim 1, wherein the UE starts monitoring PDCCH for OD-SIB1 after the indication is received if the UE receives the indication indicating system information status change of the cell and the UE acquires OD-SIB1 in response to reception of the indication.

3. The method of claim 1, wherein the UE starts monitoring PDCCH for OD-SIB1 after a starting slot of time window for monitoring the RAR if the UE acquires OD-SIB1 not in response to reception of the indication.

4. The method of claim 1, wherein the UE starts monitoring PDCCH for OD-SIB1 after a time offset from a starting slot of time window for monitoring the RAR if the UE acquires OD-SIB1 not in response to reception of the indication.

5. The method of claim 1, wherein the RAR is received in response to transmission of OD-SIB1 request.

6. The method of claim 1, wherein the UE does not initiate a random access procedure for requesting OD-SIB1 if the UE acquires OD-SIB1 in response to the reception of the indication.

7. The method of claim 1, wherein the UE initiates a random access procedure for requesting OD-SIB1 if the UE acquires OD-SIB1 not in response to reception of the indication.

8. The method of claim 1, wherein system information status change is one or more of system information change or public warning system (PWS) notification.

9. A method for a base station, comprising:
the base station starts transmitting Physical Downlink Control Channel (PDCCH) for On-Demand System Information Block 1 (OD-SIB1) for a cell based on a timing that an indication is transmitted if the base station transmits the indication indicating system information status change of the cell; and
the base station starts transmitting PDCCH for OD-SIB1 for the cell based on a time window for a Random Access Response (RAR) if the base station receives OD-SIB1 request.

10. The method of claim 9, wherein the cell is configured with OD-SIB1.

11. The method of claim 9, wherein the base station starts transmitting PDCCH for OD-SIB1 after the indication is transmitted if the base station transmits the indication indicating system information status change of the cell.

12. The method of claim 9, wherein the base station starts transmitting PDCCH for OD-SIB1 after a starting slot of time window for the RAR if the base station receives OD-SIB1 request.

13. The method of claim 9, wherein the base station starts transmitting PDCCH for OD-SIB1 after a time offset from a starting slot of time window for the RAR if the base station receives OD-SIB1 request.

14. The method of claim 9, wherein the RAR is in response to reception of OD-SIB1 request.

15. The method of claim 9, wherein OD-SIB1 is transmitted without OD-SIB1 request from a UE if the base station transmits the indication indicating system information status change of the cell.

16. The method of claim 9, wherein OD-SIB1 is transmitted in response to OD-SIB1 request from a UE if the base station does not transmit the indication indicating system information status change of the cell.

17. The method of claim 9, wherein system information status change is one or more of system information change or public warning system (PWS) notification.
